(19) United States
(12) Patent Application Publication
(10) Pub. No.: US 2017/0221593 A1
(43) Pub. Date: Aug. 3, 2017

(54) USING ADDITIVE MANUFACTURING TO PRODUCE SHIELDING OR MODULATING MATERIAL FOR NUCLEAR DETECTORS

(71) Applicant: Edgar R. Alvarez, Houston, TX (US)

(72) Inventor: Edgar R. Alvarez, Houston, TX (US)

(73) Assignee: BAKER HUGHES INCORPORATED, Houston, TX (US)

(21) Appl. No.: 15/013,560

(22) Filed: Feb. 2, 2016

(51) Int. Cl. G21F 5/015; B29C 67/00; G01V 5/04; B22F 3/105; G21F 5/06; G21F 1/00

(52) U.S. Cl. CPC G21F 5/015; G21F 5/06; G21F 1/00; G01V 5/04; B22F 3/1055; B29C 67/0085; B33Y 10/00

(57) ABSTRACT

An apparatus for a nuclear detector of a downhole tool and method of manufacturing the apparatus is disclosed. The apparatus includes a single multi-metallic component manufactured using additive manufacturing, wherein the component includes at least a first material having a first density and a second material having a second density. The method includes using additive manufacturing to form the component so that the component includes at least a first material having a first density and a second material having a second density and the first material and the second material form the single multi-metallic component.

### BACKGROUND

The present invention is related to nuclear detector components in downhole tools and in particular provides a method for manufacturing components of a nuclear detector for the downhole tool.

Current technology for petroleum exploration includes formation evaluation sensors or detectors that are conveyed downhole into a wellbore penetrating an earth formation. Current methods of constructing or manufacturing detectors include fitting together multiple components using various fastening equipment (i.e., screws, bolts, etc.) that hold the components in place. The more individual components and fasteners a detector has, the harder it is to manufacture the detector so as to maintain a high degree of mechanical alignment when placed in a harsh downhole environment.

### BRIEF DESCRIPTION

A method of manufacturing a nuclear detector for a downhole tool includes: using additive manufacturing to form a component of the nuclear detector, wherein the component includes at least a first material having a first density and a second material having a second density and the first material and the second material form a single multi-metallic component.

An apparatus for use with a nuclear detector of a downhole tool includes: a single multi-metallic component manufactured using additive manufacturing, wherein the component includes at least a first material having a first density and a second material having a second density.

### BRIEF DESCRIPTION OF THE DRAWINGS

The following descriptions should not be considered limiting in any way. With reference to the accompanying drawings, like elements are numbered alike:

FIG. 1 shows a downhole tool that includes a detector for detecting radiation levels in a downhole environment made in accordance with one embodiment of the invention;

FIG. 2A shows top view of the hatch cover of the detector;

FIG. 2B shows a bottom view of the hatch cover in one embodiment;

FIG. 2C shows a side view of the hatch cover in one embodiment;

FIG. 2D shows an end view of the hatch cover as seen along line A-A drawn in FIG. 2C;

FIG. 3 shows a bottom view of the hatch cover in an alternate embodiment;

FIG. 4 shows a fluid displacer device that can be used with the nuclear detector of the downhole tool in one embodiment of the present invention;

FIG. 5 shows a section of a downhole tool string in one embodiment of the present invention;

FIG. 6 shows a detailed view of a radiation component from the downhole tool string in one embodiment of the present invention; and

FIG. 7 shows an illustrative embodiment of an apparatus for creating the various components disclosed herein.

### DETAILED DESCRIPTION

A detailed description of one or more embodiments of the disclosed apparatus and method are presented herein by way of exemplification and not limitation with reference to the Figures.

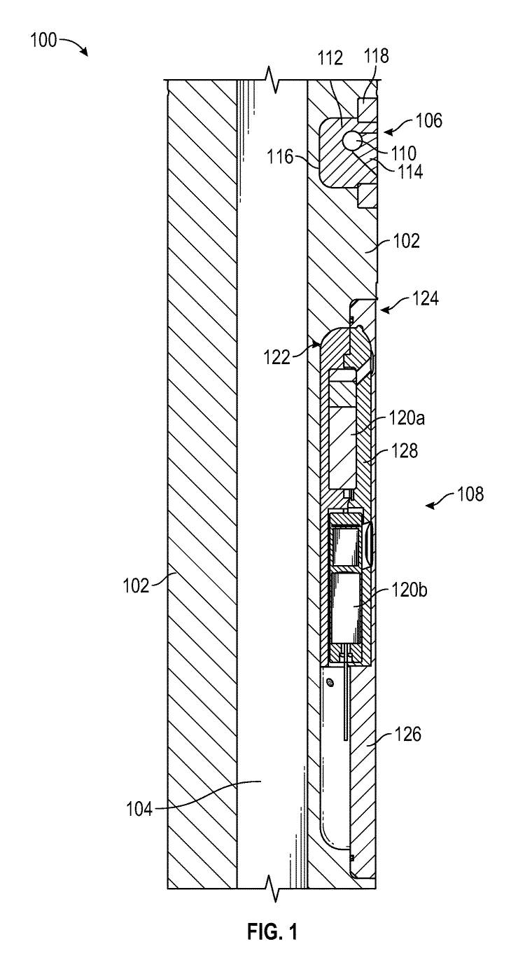

FIG. 1 shows a downhole tool 100 that includes a detector for detecting radiation levels in a downhole environment made in accordance with one embodiment of the invention. In one embodiment, the downhole tool 100 includes a tubular member 102 such as a drill string having a flow bore 104 therethrough. It is to be understood, however the type of downhole tool 100 is not meant as a limitation on the invention. The tubular member 102 includes a radiation component 106 for providing a source of radiation and a detector component 108 for detecting radiation levels. The radiation levels that are measured can be natural radiation from a formation or radiation resulting from interaction of radiation from the radiation component 106 with the formation. The radiation component 106 provides a radioactive material 110 and various elements or structures that support the radioactive material 110 within the tubular member 102. Similarly, the detector component 108 includes radiation detectors 120a, 120b and various elements or structures that support the radiation detectors 120a, 120b within the tubular member 102.

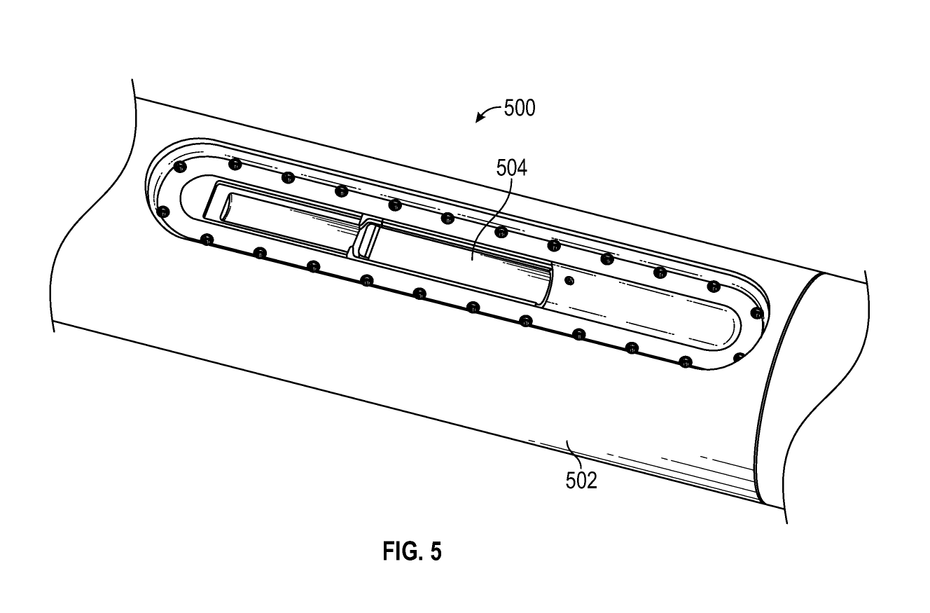

The radiation component 106 includes a source receptacle 112 and a window 114 that is placed over a top of the source receptacle 112. The source receptacle 112 and window 114 can be made as a single seamless component using additive manufacturing techniques as described herein. A radioactive material 110 is encased or enclosed by the source receptacle 112 and window 114. The radioactive material 110 can placed in a cavity formed in the source receptacle 112 and window 114 via an opening in the source receptacle 112, as discussed below with respect to FIG. 5. The source receptacle 112, window 114 and radioactive material 110 can then be placed in cavity 116 formed in the tubular member 102. The source receptacle 112 can be made of a high density shielding material such as tungsten or tungsten alloy, which protects the tubular member 102 and flow bore 104 from radiation from the radioactive material 110. The window 114 can be made of a low density material such as titanium, titanium alloy or thermoplastic, which allows radiation from the radioactive material 110 irradiate the formation. The source receptacle 112 can be manufactured during the additive manufacturing process to have a contour on its outer surface that matches a contour of the cavity 116 into which the source receptacle 112 is placed. In one embodiment, the radiation component 106 can have a flanged section 118 which includes holes or other securing devices for securing the radiation component 106 into the cavity 116.

The detector component 108 includes one or more radiation detectors 120a, 120b encased or enclosed by various elements. The radiation detectors 120a, 120b can include a scintillating material that emits photons in response to incident radiation, such as a sodium-iodide (NaI) crystal. A photomultiplier (not shown) receives a photons emitted by radiation detectors 120a, 120b and produces a voltage in response to the received plurality of photons. The voltage is measured and sent to a processor (not shown) that uses the measured voltage to determine a level of radiation from the formation, which can be used to determine a composition or lithology of the formation.

The detector component 124 further includes a detector receptacle 122 and a hatch cover 124 to support radiation detectors 120a, 120b. The detector receptacle 122 can be manufactured into the tubular member 102 during an additive manufacturing process and provides a cavity into which the radiation detectors 120a, 120b can be placed. The hatch cover 124 can then be placed over the radiation detectors 120a, 120b and secured to the tubular member 102 to retain the radiation detectors 120a, 120b in the detector receptacle 122. The hatch cover 124 includes an outer cover 126 which can be made of a low density material such as titanium or titanium alloy. Formed within the outer cover 126 is a shield 128 which can be made of a high density material such as tungsten or tungsten alloy. When the hatch cover 124 is secured to the tubular member 102, the shield 128 and the detector receptacle 122 enclose the radiation detectors 120a, 120b, securing the radiation detectors 120a and 120b within the tubular member 102. The shield 128 can be manufactured so that a contour of its inner surface matches a contour of an outward facing portion of the radiation detectors 120a, 120b. Similarly, the detector receptacle 122 can be manufactured so that a contour of its inner cavity matches a contour of an inward facing portion of the radiation detectors 120a, 120b. As discussed below, various elements of the tool 100 may be manufactured using additive manufacturing techniques, such as the radiation component 106, the hatch cover 124, the detector receptacle 112, etc.

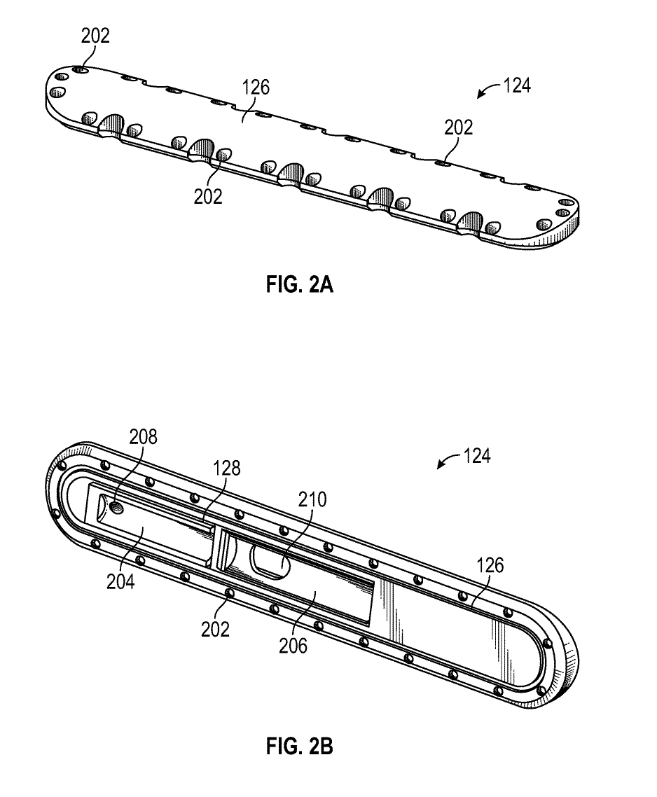

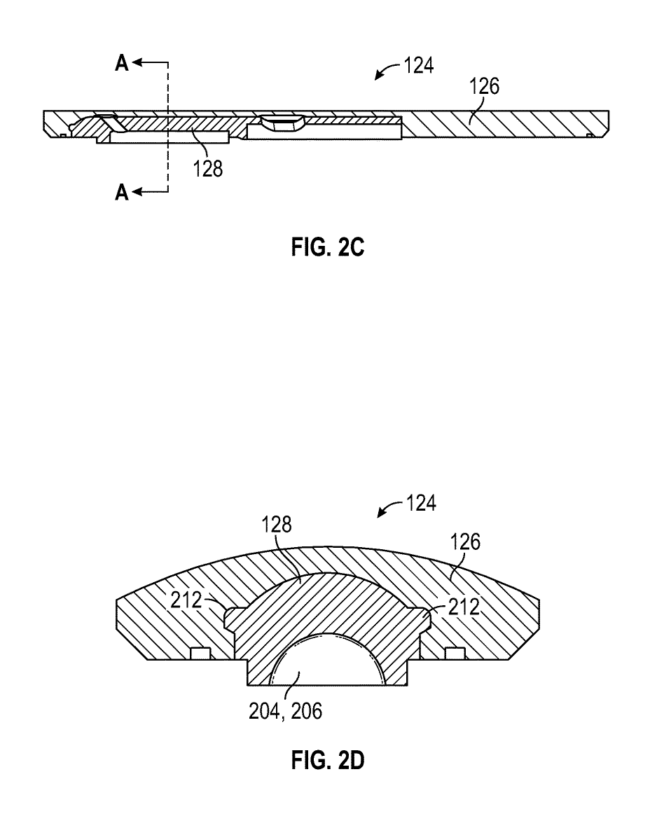

FIGS. 2A-2D illustrate various views of the hatch cover 124 of the detector component 108 of the downhole tool 100 in one embodiment of the present invention. FIG. 2A shows top view of the hatch cover 124 showing an outer surface of outer cover 126. The outer surface of the outer cover 126 faces the borehole when the tool (100, FIG. 1) is deployed downhole and shields the radiation detectors 120a, 120b from the downhole environment. The curvature of the outer surface can be formed to match a curvature of the tubular member (102, FIG. 1) In one embodiment, the outer cover 126 is made of a low density material such as titanium or titanium alloy. Holes 202 are formed in the outer cover 126 through which securing devices, such as bolts or screws, can be used to secure the hatch cover 124 to the tubular member 202.

FIG. 2B shows a bottom view of the hatch cover 124 in one embodiment. The outer cover 126 is shown with holes 202 for securing the hatch cover 124 to the tubular member 102. The shield 128 is formed within a concave depression in the outer cover 126. The shield 128 includes cavities 204 and 206 formed therein for retaining radiation detectors 120a and 102b, respectively. Opening 208 in shield 128 allows radiation into cavity 204 for detection by radiation detector 120a. Similarly, opening 210 allows radiation into cavity 206 for detector by radiation detector 120b.

FIG. 2C shows a side view of the hatch cover 124 showing the outer cover 126 and shield 128 in one embodiment. FIG. 2D shows an end view of the hatch cover 124 as seen along line A-A drawn in FIG. 2C. The outer cover 126 and shield 128 are shown in cross-section. Cavities 204, 206 are represented by half-circles in FIG. 2D. Flanged sections 212 of the shield 218 can help secure the shield 218 into the outer cover 126.

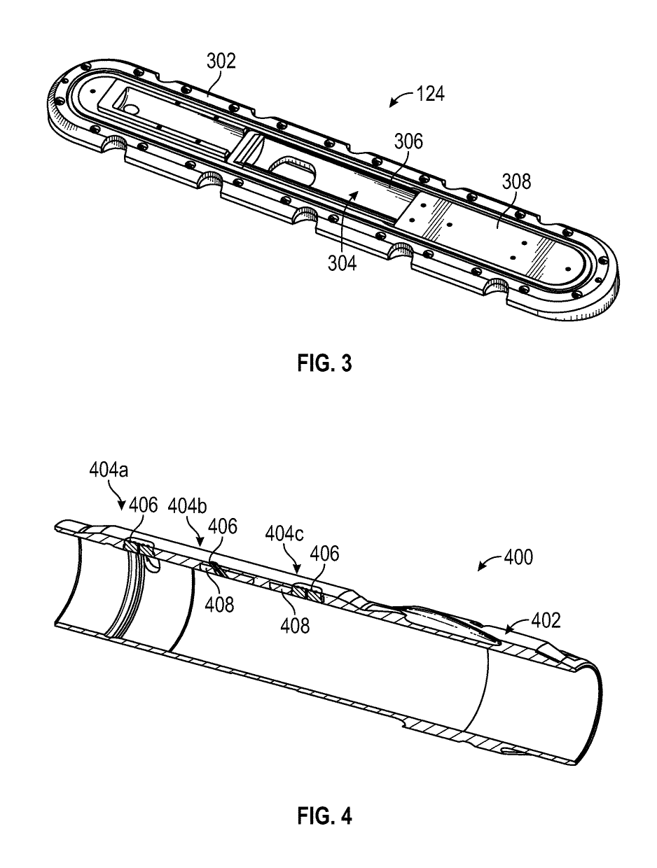

FIG. 3 shows a bottom view of the hatch cover 124 in an alternate embodiment. The shield 128 includes a bimetallic structure. The hatch cover 124 includes outer cover 302 made of a first material having a first density. The shield 304 is made of a second material 306 having a second density and a third material 308 having a third density. In one embodiment, the first material can be titanium or titanium alloy, the second material 217 can be tungsten or tungsten alloy and the third material 319 can be aluminum or aluminum alloy.

In various embodiments, the hatch cover 124 can be manufactured using an additive manufacturing process in which the hatch cover 124, including the outer cover 126 and shield 128, is formed layer by layer, with each layer being formed on top of the previous layer. The additive manufacturing technique may include a process in which a computer design of the manufactured part is used to move a probe to a selected location, at which location the probe deposits a liquefied drop of a selected material. The liquefied drop then solidified at the deposited location. The computer design then moves the probe to other locations to deposit additional drops of the material, which solidify in their locations. By depositing multiple drops, the probe can build a first layer of a component and then build a second layer on top of the first layer, and so forth, until the component is completed. Each layer can be made differently in order to produce the features shown on the hatch cover 124 in FIGS. 2A-2D and/or FIG. 3, i.e., the curvature of the outer cover 126, holes 202, shield 128, including cavities 204, 206 and openings 208, 210 and flanges 212. In addition, the probe can deposit multiple materials on a selected layer and is not limited to depositing only a single material. Therefore, additive manufacturing techniques can be used to form a single hatch cover 124 out of two or more metals without use of adhesive or fastening equipment. The material of the outer cover 126 and the material of the shield 128 can be bonded to each other during the additive manufacturing process by deposition, melting, sintering, etc. When the hatch cover 124 includes additional metals, these additional metals can similarly be bonded to each other.

In a design stage, the shape of the shield 128 and of the outer cover 126 can be selected to provide a selected shielding level based on a shape of collimated windows or based on a combination of materials. The shield 128 and the outer cover 126 can then be formed as a single component and therefore without a need for fasteners to fasten one to the other. While the additive manufacturing process is discussed above with respect to forming a hatch cover 124, this process can also be used to form other components of the downhole tool, as discussed below.

FIG. 4 shows a fluid displacer device 400 that can be used with the nuclear detector of the downhole tool 100 in one embodiment of the present invention. The fluid displacer 400 includes a steel shell 402 that has various windows 404a-404c that are transparent or substantially transparent to radiation. The windows 404a-404c allow radiation to pass through in order to be detected at the nuclear detector. The shape of the windows 404a-404c and the type of materials used to form the windows 404a-404c can be selected in order to provide a collimated beam of radiation from the formation to the detector and/or to provide a selected route for the radiation. For example, window 404a includes a low density material 406 such as a thermoplastic and provides a wide channel for radiation to pass. Window 404b includes a low density material 406 such as a thermoplastic and a high density material 408 such as tungsten or tungsten alloy that are configured to provide a narrow collimated channel at an angle to the steel shell for radiation to pass. Window 404c includes a low density material 406 such as a thermoplastic and a high density material 408 such as tungsten or tungsten alloy that are configured to provide a narrow collimated channel oriented along a radial line of the steel shell for radiation to pass. A design of the windows 404a-404c can be decided upon during a design stage of the fluid displacer 400. In one embodiment, additive manufacturing processes can be used to manufacture the fluid displacer as a single piece, by depositing steel, tungsten or tungsten alloy and thermoplastic material in multiple layers. In alternate embodiments, the fluid displacer 400 can be made using materials other than steel, tungsten or tungsten alloy and thermoplastic.

FIG. 5 shows a section 500 of a tool string in one embodiment of the present invention. The section 500 can include a tubular member 502, such as a drill collar, that has formed therein a cavity for supporting a radiation detector. A shielding material 504 is manufactured into the cavity in order to form a receptacle for the radiation detector. The section 500 may be made of steel or other suitable material and the shielding material 504 can be made of tungsten. The tubular member 502 and shielding material 504 can be formed as a single unit to form section 500 using the additive manufacturing techniques discussed above.

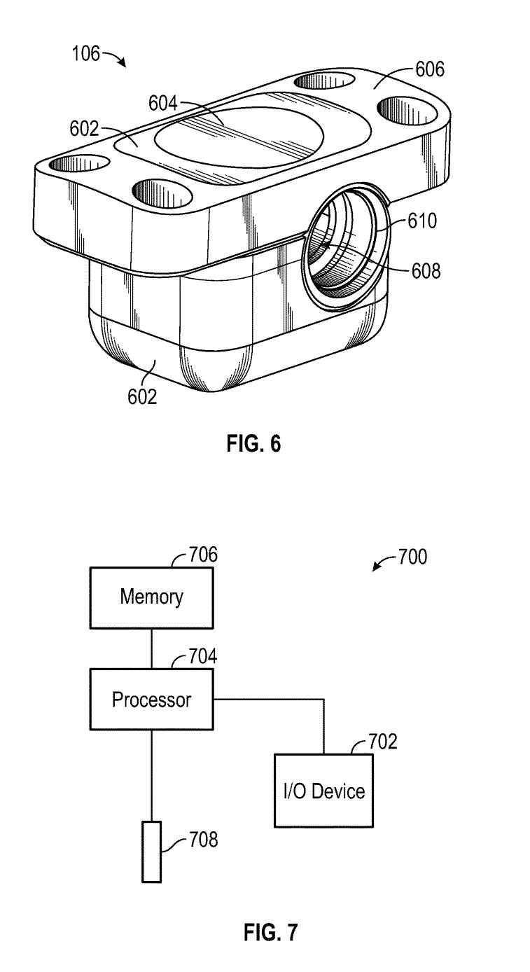

FIG. 6 shows a detailed view of the radiation component 106 from the tool string 100 in one embodiment of the present invention. The radiation component 106 includes a receptacle 602 that includes a high density shield material such as tungsten or tungsten alloy. The receptacle 602 provides a cavity into which radioactive material can be placed. A window 604 forms a cap to the cavity formed by the receptacle 604. The window 604 can be made from a low density material such as thermoplastic. A flange 606 can be formed at a top surface of the receptacle 602. The flange 606 secures the receptacle 602 and window 604 to the tool 100. In one embodiment, the flange 606 can be made of a structural material such as steel. The receptacle 602 can include an opening 608 in its side in order to receive the radioactive material. The opening 608 can be provided with a layer of anti-galling material 610 to reduce wear. In one embodiment, the anti-galling material 610 can be made of copper or copper alloy. In one embodiment, the radiation component 106 can be manufactured as a single component using additive manufacturing. Therefore, the receptacle 602, window 604, flange 606 and anti-galling material 610 may be a single seamless component.

FIG. 7 shows an illustrative embodiment of an apparatus 700 for creating the various components disclosed herein. The apparatus 700 includes an input/output device 702 that allows an operator or user to design the component according to a desired specification. The design can be stored in a memory location 706 as computer-readable instructions for later use in a manufacturing stage. During manufacture, processor 706 reads the instructions and operates probe 708 according to the instructions perform the additive manufacturing process disclosed herein to manufacture the component.

Set forth below are some embodiments of the foregoing disclosure:

Embodiment 1: A method of manufacturing a nuclear detector for a downhole tool, including using additive manufacturing to form a component of the nuclear detector, wherein the component includes at least a first material having a first density and a second material having a second density and the first material and the second material form a single multi-metallic component.

Embodiment 2: The method of embodiment 1, wherein the component includes a hatch cover for a nuclear detector, the method further comprising using additive manufacturing to form the hatch cover including an outer cover and a shield, wherein the outer cover is made of the first material and the shield is made of at least the second material.

Embodiment 3: The method of embodiment 2, wherein the shield further comprise a third material having a third density and the first material, the second material and third material are formed in a single additive manufacturing step.

Embodiment 4: The method of embodiment 2, wherein the first material includes titanium and the second material includes tungsten.

Embodiment 5: The method of embodiment 1, wherein the component supports a radioactive material and includes a receptacle made of the second material and a window made of the first material.

Embodiment 6: The method of embodiment 5, wherein the high density material includes tungsten and the low density material includes a thermoplastic.

Embodiment 7: The method of embodiment 1, wherein a top surface of the component is flush with an outer surface of the downhole tool when attached to the downhole tool.

Embodiment 8: The method of embodiment 1, wherein the component is a section of a tubular member of a downhole tool and includes a receptacle for receiving a radiation detector.

Embodiment 9: An apparatus for use with a nuclear detector of a downhole tool, comprising: a single multi-metallic component manufactured using additive manufacturing, wherein the component includes at least a first material having a first density and a second material having a second density.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

1. A method of manufacturing a nuclear detector for a downhole tool, comprising:
forming a hatch cover of the nuclear detector from at least a first material having a first density and a second material having a second density, wherein forming the hatch includes using additive manufacturing to form a layer of the hatch cover by depositing liquefied drops of at least one of the first material and the second material and allowing the liquefied drops to solidify; and
attaching the hatch cover to the downhole tool to cover a receptacle in the downhole tool for the nuclear detector.

2. The method of claim 1, further comprising forming the hatch cover to include an outer cover and a shield, wherein the outer cover is made of the first material and the shield is made of at least the second material.

3. The method of claim 2, wherein the shield further comprise a third material having a third density and the first material, the second material and third material are formed in a single additive manufacturing step.

4. The method of claim 2, wherein the first material includes titanium and the second material includes tungsten.

5. The method of claim 1, wherein the component supports a radioactive material and includes a receptacle made of the second material and a window made of the first material.

6. The method of claim 5, wherein the first material includes tungsten and the second material includes a thermoplastic.

7. The method of claim 1, wherein a top surface of the hatch cover is flush with an outer surface of the downhole tool when attached to the downhole tool.

8. The method of claim 1, further comprising forming the receptacle for receiving the nuclear detector in a section of the downhole tool using additive manufacturing.

9. An apparatus for use with a nuclear detector of a downhole tool, comprising:
a single multi-metallic hatch cover to the nuclear detector, wherein the component includes at least a first material having a first density and a second material having a second density.

10. The apparatus of claim 9, wherein hatch cover includes an outer cover made of the first material and a shield made of at least the second material.

11. The apparatus of claim 10, wherein the shield further comprises a third material having a third density and the first material, the second material and third material are formed in a single additive manufacturing step.

12. The apparatus of claim 10, wherein the first material includes titanium and the second material includes tungsten.

13. The apparatus of claim 9, wherein the hatch cover supports a radioactive material and includes a receptacle made of the second material and a window made of the first material.

14. The apparatus of claim 9, further comprises a section of the downhole tool having a receptacle for the nuclear detector.

15. The apparatus of claim 9, wherein the downhole tool further comprises a steel shell.
